(19) United States
(12) Patent Application Publication
(10) Pub. No.: US 2010/0068456 A1
(43) Pub. Date: Mar. 18, 2010

(54) DECORATIVE FILM AND SHELL INCORPORATING THE SAME

(75) Inventors: Che-Yuan Hsu, Shindian (TW); Cheng-Wen Su, Shindian (TW); Gang Huang, Shenzhen City (CN); Yan-Min Wang, Shenzhen City (CN); Qiang Wang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/503,730

(22) Filed: Jul. 15, 2009

(30) Foreign Application Priority Data
Sep. 16, 2008 (CN) 200810304522.5

(51) Int. Cl. B32B 3/10

(52) U.S. Cl. 428/138; 428/137

(57) ABSTRACT

A decorative film and a shell using the decorative film are provided. The decorative film includes a first decorative and a second decorative layer. The first decorative layer defines a plurality of first decorative holes. The second decorative layer is directly formed on the first decorative layer and has a plurality of second decorative holes defined. A combination of the plurality of second decorative holes and the plurality of first decorative holes can achieve a three-dimensional appearance.

### CROSS-REFERENCE TO RELATED APPLICATION

This application is related to co-pending U.S. Patent Application (Attorney Docket Nos. US20904, entitled “DECORATIVE FILM AND SHELL INCORPORATING THE SAME”, by CHE-YUAN HSU et al., which is the same assignee as the present application. The above-identified application is incorporated herein by reference.

### BACKGROUND

1. Technical Field

The present disclosure relates to a decorative film and a shell incorporating the same.

2. Description of Related Art

Shells for portable electronic devices are usually decorated with patterns to improve the aesthetic appearance. The patterns may be directly printed/coated on the exterior surface of the shells. However, the printed/coated patterns can be difficult and costly to achieve a three-dimensional appearance.

Therefore, there is room for improvement within the art.

### BRIEF DESCRIPTION OF THE DRAWING

Many aspects of the new housing and method for fabricating the same can be better understood with reference to the following drawings. The components in the drawings are not necessarily drawn to scale, the emphasis instead being placed upon clearly illustrating the principles of the new housing and method for fabricating the same. Moreover, in the drawings, like reference numerals designate corresponding parts throughout the several views.

FIG. 1 is a cross-sectional view of a decorative film according to an exemplary embodiment.

FIG. 2 is a cross-sectional view of a shell incorporating the decorative film shown in FIG. 1.

### DETAILED DESCRIPTION

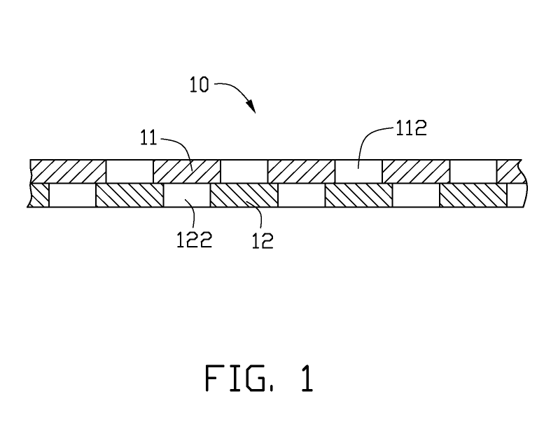

FIG. 1 shows an exemplary decorative film 10 including a first decorative layer 11 and a second decorative layer 12 directly formed on the first decorative layer 11.

The first decorative layer 11 can be of any color and transparency degree and define a plurality of first decorative holes 112 therethrough. Each of the first decorative holes 112 can have a different shape and all the holes 112 as a group can be arranged in various patterns, such as a circular pattern, a triangular pattern or a rectangular pattern.

The second decorative layer 12 can be of any color and transparency degree. However, the color of the second decorative layer 12 is different from the first decorative layer 11. A plurality of second decorative holes 122 are defined through the second decorative layer 12. The second decorative holes 122 as a group may have substantially the same arrangement as the first decorative holes 112, while the first decorative holes 112 can be displaced relative to and above the second decorative holes 122. As such, each second decorative hole 122 aligns below the portion between each two adjacent first decorative holes 112. The second decorative layer 12 can be hot-formed on the surface of the first decorative layer 11.

Due to different colors of the first decorative layer 11 and the second decorative layer 12 and the arrangement of the first decorative holes 112 relative to the second decorative holes 122, the decorative film 10 has a three-dimensional appearance.

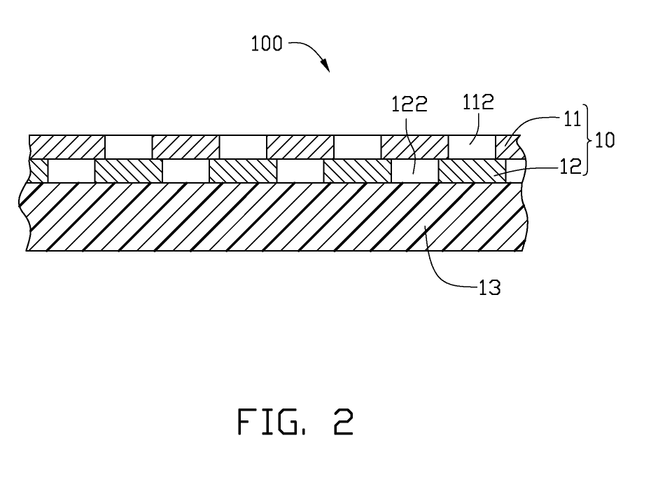

FIG. 2 shows an exemplary shell 100 having the decorative film 10 integrally formed on its base shell 13. The base shell 13 can be injection molded to the decorative film 10 and made of a plastic material selected from a group consisting of Polyethylene (PE), polyamide (PA), polycarbonate (PC), acrylonitrile-butadiene-styrene (ABS), polymethyl methacrylate (PMMA) and polyethylene terephthalate (PET). Specifically, the base shell 13 is directly formed on the second decorative layer 12 of the decorative film 10. Meanwhile, the second decorative layer 12 is located between the base shell 13 and the first decorative layer 11.

It is to be understood, however, that even through numerous characteristics and advantages of exemplary embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A decorative film, comprising:
a first decorative layer defining a plurality of first decorative holes therethrough; and
a second decorative layer directly formed on the first decorative layer, the second decorative layer defining a plurality of second decorative holes therethrough, a combination of the plurality of second decorative holes and the plurality of first decorative holes configured to achieve a three-dimensional appearance.

2. The decorative film as claimed in claim 1, the plurality of second decorative holes having substantially the same arrangement as the plurality of first decorative holes.

3. The decorative film as claimed in claim 2, wherein the first decorative layer is provided with any color and transparency degree.

4. The decorative film as claimed in claim 3, wherein the second decorative layer is provided with any color and transparency degree, and the color of the second decorative layer is different from the color of the first decorative layer.

5. The decorative film as claimed in claim 2, wherein the plurality of first and second decorative holes are rectangular-arranged, triangularly arranged, or circularly arranged.

6. The decorative film as claimed in claim 2, wherein each of the second decorative holes aligns below the portion between each adjacent two of the first decorative holes.

7. The decorative film as claimed in claim 2, wherein the second decorative holes are displaced relative to the first decorative holes.

8. A shell, comprising:
a base shell; and
a decorative film directly formed on the base shell, the decorative film as claimed in claim 1.

9. The shell as claimed in claim 8, wherein the second decorative layer is directly formed on the base shell.

10. The shell as claimed in claim 8, wherein the first decorative layer is provided with any color and transparency degree.

11. The shell as claimed in claim 10, wherein the second decorative layer is provided with any color and transparency degree, and the color of the second decorative layer is different from the color of the first decorative layer.

12. The shell as claimed in claim 8, wherein the plurality of first and second decorative holes are rectangular-arranged, triangularly arranged, or circularly arranged.

13. The shell as claimed in claim 8, wherein each of the second decorative holes aligns below the portion between each adjacent two of the first decorative holes.

14. The shell as claimed in claim 8, wherein the second decorative holes are displaced relative to the first decorative holes.
